(19) United States
(12) Patent Application Publication
(10) Pub. No.: US 2009/0200835 A1
(43) Pub. Date: Aug. 13, 2009

(54) LAMINATED VEHICLE WALL

(75) Inventors: Jan Nilsson, Hisings-Karra (SE); Bo Olofsson, Frolunda (SE); Martin Hoban, Torslanda (SE); Raimo Tenhunen, Myggenas (SE); Michael Dyverfors, Savedalen (SE)

Correspondence Address: WRB-IP LLP, 1217 KING STREET, ALEXANDRIA, VA, 22314, US

(73) Assignee: VOLVO LASTVAGNAR AB, Goteborg (SE)

(21) Appl. No.: 12/293,288

(22) PCT Filed: Mar. 28, 2006
(86) PCT No.: PCT/SE2006/000385

§ 371 Date: Sep. 17, 2008

(51) Int. Cl. B62D 33/06; B62D 25/14; B62D 65/02; B62D 65/14

(52) U.S. Cl. 296/190.08; 296/193.02; 29/428

(57) ABSTRACT

A vehicle body with a laminated wall includes a first wall and a second wall that is fixedly attached to the vehicle body and provided with a plurality of receiving openings. The first wall can have a plurality of assembly openings each provided with at least one sub-unit so as to form a substantially complete sub-assembly of the vehicle body, and each being arranged so as to substantially coincide with a corresponding receiving opening when the outer side of the first wall is attached to the inner side of the second wall. The outer side of the first wall can be attached to the inner side of the second wall so that each assembly opening substantially coincides with at least one receiving opening to form the laminated wall.

### BACKGROUND AND SUMMARY

The present invention relates to a sub-assembly in a vehicle body, e.g. a cockpit module in a cab for a cargo carrying truck, a bus, a car or any other vehicle within the automotive industry, or even a cabin for a train, a boat or an airplane.

In modern, efficient production of vehicles it is common to assemble larger sub-assemblies prior to a final installation in the vehicle, e.g. prior to a final installation in the cab of a vehicle. A sub-assembly can e.g. be a cockpit module comprising such units as a steering wheel adjustment, a climate system, a pedal plate but also an electrical central etc, i.e. a substantially complete cockpit assembly. Thus, it is well known per se to install a pre-assembled cockpit module into the cab of a vehicle.

However, cockpit modules are often pre-assembled in a mounting jig or fixture or in some other support arrangement which is detached after an assembly of the module. This is a clear disadvantage since the measures and other conditions of jigs, fixtures and the like must always be keep under thorough control to ensure that no errors are introduced into the assembled parts. The control is time-consuming especially considering that a manufacturer may have a plurality of support arrangements in different assembly plants. In addition, even the most rigorous control cannot fully eliminate the fact that mounting jigs and fixtures and the like represent potential sources of error in the production.

Hence, cockpit modules and other larger sub-assemblies should preferably be pre-assembled without the use of any mounting jig or fixture or the like. Some attempts have also been made in prior art to improve the pre-assembling of a cockpit module in this respect.

The European patent EP 0 736 445 B1 discloses a truck cab composed of two pre-assembled modules; a part cab module and a front module. The part cab module is based on a cab shell which is open at the front, i.e. the front wall is fully detached. The front module is based on the fully detached front wall of the cab, which wall serves as a system carrier and is completed by the attachment of at least a majority of vehicle pans and units arranged in the cab front area.

The U.S. Pat. No. 5,863,093 discloses a firewall-dashboard assembly which facilitates easier installation and assembly of certain components. Specifically, the firewall is pre-assembled and combined with a dashboard sub-assembly prior to mounting these components to the truck cab. The firewall-dashboard assembly contains at least the instrument panel and the brake, clutch, and accelerator mechanisms.

The above patents disclose a cockpit module which is pre-assembled by using the entire front wall (firewall) of the cab as a mounting jig or fixture. In other words, the entire front wall is detached from the cab. However, the use of the entire firewall as a loose mounting jig or fixture for assembling a cockpit module involves several drawbacks.

A first exemplifying drawback is that the use of an entire front wall (firewall) as a mounting jig or fixture gives a large and heavy jig or fixture. This makes a handling of the jig or fixture and the complete assembled cockpit module more difficult. This is especially so if the front wall (firewall) e.g. comprises heavy reinforcing beams, e.g. beams for crashworthiness.

Another exemplifying drawback is that a cab without front wall (firewall) suffers from an increased instability in the structure, which may increase the risk for damages during assembly of the cab. Hence, for stability reasons it would be better to keep the front wall (firewall) in place during the assembly of the cab.

A further exemplifying drawback is that parts to be mounted on both the firewall and the cab cannot be mounted until the front wall (firewall) is mounted. Hence, it would be better to keep the front wall (firewall) in place to enable such mounting at an early stage of the cab assembling.

In addition, the front wall (firewall) is typically used as a lower support for the cab windscreen. The mounting of a detached loose front wall (firewall) provided with cockpit units onto the cab will therefore require a thorough and complicated fitting with respect to the cab so as to cause no extra tension in the windscreen or water leakage at the edges of the windscreen or the edges of the mounted front wall (firewall). The complicated fitting is i.a. related to the tolerances of the cab and the loose front wall (firewall). It is also caused by the plurality of different joints (cab<->firewall; cab<->windscreen; firewall<->windscreen) of different nature needing different joining and/or sealing means such as glues etc that are not always compatible with each other. Hence, to form a smooth and continuous cab surface suitable for the fitting of a windscreen it would be better to have the front wall (firewall) fixedly attached to the cab during the assembly of the cab.

Hence, there is a need for an improved sub-assembly for vehicles and an improved method for pre-assembling such sub-assemblies, which obviates or mitigates at least one of the above drawbacks.

An aspect of the present invention provides a first wall adapted to form a part of a laminated wall in a vehicle body. The laminated wall comprises the first wall and a second wall, wherein the second wall is fixedly attached to the vehicle body and provided with a plurality of receiving openings.

The first wall is particularly characterized in that: the first wall has a plurality of assembly openings each adapted to be provided with at least one sub-unit so as to form a substantially complete sub-assembly of the vehicle body; and each assembly opening is arranged so as to substantially coincide with a corresponding receiving opening to form said laminated wall when the outer side of the first wall is attached to the inner side of the second wall.

At least one of the assembly openings in the first wall can be unique with respect to e.g. shape and size so as to be particularly adapted with small tolerances for mounting of one or several specific sub-units.

In addition, the inner side of the first wall can be provided with at least one assembly means—e.g. such as an assembly bracket or a framework—to facilitate a mounting of sub-units into the assembly openings.

It is also preferred the inner side of the first wall is provided with sub-units mounted in the assembly openings so as to form a substantially complete sub-assembly—e.g. a cockpit module—to be mounted in the vehicle body.

It is particularly preferred that first wall is the inner wall in a laminated wall constituting a partition wall (firewall) arranged in front of the seat positions in a vehicle body in the form of a cab for a cargo carrying truck.

An aspect of the present invention is also providing a vehicle body with a laminated wall. The laminated wall comprises the first wall and a second wall, wherein the second wall is fixedly attached to the vehicle body and provided with a plurality of receiving openings.

The vehicle body is particularly characterized in that: the first wall has a plurality of assembly openings each provided with at least one sub-unit so as to form a substantially complete sub-assembly of the vehicle body, and each being arranged so as to substantially coincide with a corresponding receiving opening when the outer side of the first wall is attached to the inner side of the second wall; the outer side of the first wall is attached to the inner side of the second wall so that each assembly opening substantially coincides with at least one receiving opening to form said laminated wall.

The first wall in the vehicle body can have at least one assembly opening that is unique with respect to e.g. shape and size so as to be particularly adapted with small tolerances for mounting of one or several specific sub-units.

It is particularly preferred that the inner side of the first wall in the vehicle body is provided with sub-units mounted in the assembly openings so as to form a substantially complete sub-assembly—e.g. a cockpit module—to be mounted in the vehicle body.

The inner side of the first wall in the vehicle body can be provided with at least one assembly means—e.g. an assembly bracket or a framework—for facilitating the mounting of sub-units into the assembly openings.

It is also preferred that the second wall in the vehicle body is provided with at least two receiving openings that are substantially symmetrically arranged on each side of the center of the second wall. In particular embodiments of the present invention this makes if possible to use the same vehicle body structure for both left-hand-traffic and right-hand-traffic.

In an advantageous embodiment of the invention, the outer side of the first wall in the vehicle body has an elongated upper recess, whereas the inner side of the second wall has a corresponding elongated upper recess, which together forms a duct. In particular embodiments of the present invention this makes it possible form a defroster duct beneath a windscreen in the vehicle body.

In a suitable embodiment of the invention, the first wall in the vehicle body is arranged a distance from the second wall so as to create a compartment between the inner and outer walls, which compartment is filled with sound insulating material. In embodiments of the present invention this makes it possible to form an improved sound insulation section beneath a windscreen in the vehicle body.

In another embodiment of the invention, the first wall in the vehicle body is fixedly attached to the second wall by means of assembly points arranged on the outside of the vehicle body. In particular embodiments of the present invention this makes it easy for an assembly robot or the like to access the assembling points for attaching the first wall to second wall.

It is particularly preferred that the vehicle body is a cab for a cargo carrying truck and the laminated wall is a partition wall (firewall) arranged in front of the seat positions in the cab.

An aspect of the present invention is also providing a method for forming a substantially complete sub-assembly (e.g. a cockpit module) of a vehicle body by using a first wall adapted to form a part of a laminated wall in the vehicle body. The laminated wall comprises the first wall and a second wall, wherein the second wall is fixedly attached to the vehicle body and provided with a plurality of receiving openings.

The method is particularly characterized by the steps of: providing a first wall having a plurality of assembly openings each being arranged so as to substantially coincide with a corresponding receiving opening to form said laminated wall when the outer side of the first wall is attached to the inner side of the second wall; providing each assembly opening with at least one sub-unit so as to form a substantially complete sub-assembly of the vehicle body.

An aspect of the present invention is additionally providing a method for mounting a substantially complete sub-assembly (e.g. a cockpit module) into a vehicle body with a laminated wall. The laminated wall comprises the first wall and a second wall, wherein the second wall is fixedly attached to the vehicle body and provided with a plurality of receiving openings.

The method is particularly characterized by the steps of: providing a substantially complete sub-assembly comprising a first wall having a plurality of assembly openings each being provided with at least one sub-unit, and each being arranged so as to substantially coincide with a corresponding receiving opening when the outer side of the first wall is attached to the inner side of the second wall; attaching the outer side of the first wall to the inner side of the second wall so that each assembly opening substantially coincides with at least one receiving opening to form said laminated wall.

It is particularly preferred that the methods are preformed on a vehicle body in the form of a cab for a cargo carrying truck, and the laminated wall is a partition wall (firewall) arranged in front of the seat positions in the cab.

Further advantages of the present invention and embodiments thereof will appear from the following detailed description of the invention.

### BRIEF DESCRIPTION OF THE DRAWINGS

FIG. 1 shows a schematic and partial inside view of a truck cab 100.

FIG. 2a shows a schematic view of the outer side of an exemplifying inner firewall 210. FIG. 2b shows the inner side of the inner firewall 210 in FIG. 2a provided with assembling brackets 213A-213D.

FIG. 3 shows a schematic view of a cockpit module 300 comprising the inner firewall 210 with cockpit sub-units mounted thereon.

FIG. 4a shows the cockpit module 300 in FIG. 3 assembled into the truck cab 100. FIG. 4b shows a cross-section of the assembled cockpit module 300 taken along the lines A-A in FIG. 4a.

### DETAILED DESCRIPTION

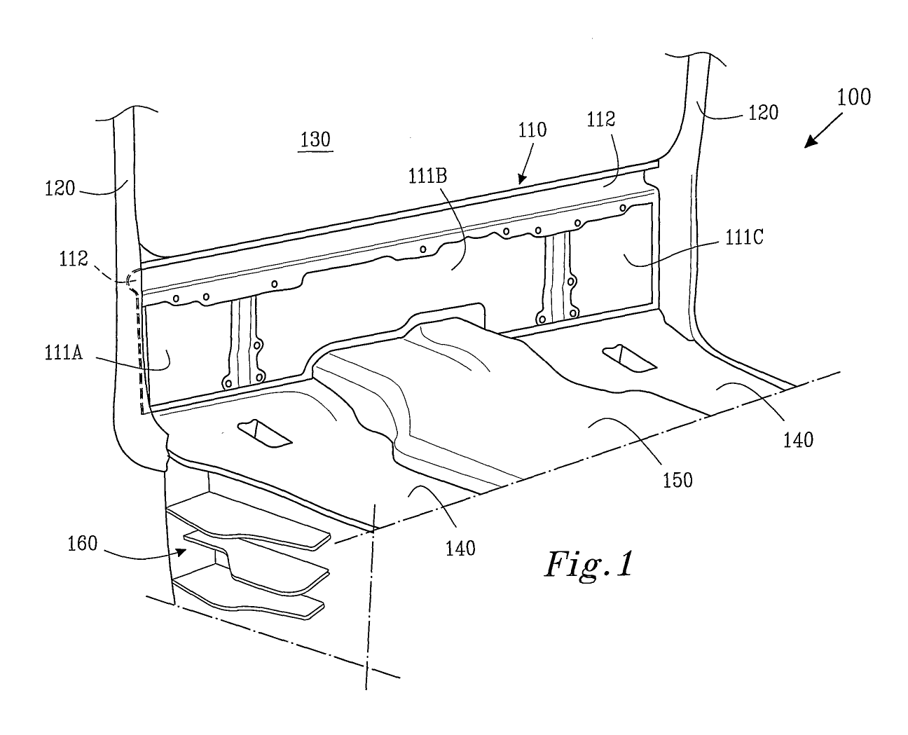

FIG. 1 shows a schematic and partial view of the inside of a vehicle body, here in the shape of an exemplifying truck cab 100. The truck cab 100 is in a stripped, so-called “body-in-white” condition with no sub-assemblies or modules yet installed.

In particular, the exemplifying truck cab 100 comprises a so-called body-in-white firewall 110, i.e. the stripped partition wall in front of the seat positions in the truck cab 100. The body-in-white firewall 110 shown in FIG. 1 is fixedly attached to the cab 100 so as to form a substantially homogenous body with the cab 100. The joint between the cab 100 and the body-in-white firewall 110 can be e.g. welded and/or soldered and worked to a smooth surface, e.g. suitable for the fitting of a windscreen.

The body-in-white firewall 110 further comprises three receiving openings 111A-111C arranged to receive different cockpit sub-units. The first left receiving opening 111A can e.g. be arranged to receive pedal plate and steering wheel adjustment units, the second center receiving opening 111B can e.g. be arranged to receive a heating, ventilation and air conditioning unit (HVAC unit), and the third right receiving opening 111C can e.g. be arranged to receive an electrical central unit. Naturally, the body-in-white firewall 110 may have receiving openings that are arranged to receive one or several sub-units and it may also have further or fewer openings of various forms and sizes and for different purposes.

The three receiving openings 111A-111C in the exemplifying body-in-white firewall 110 are separated by two substantially vertical beam-like pillars. However, it should be emphasized that the body-in-white firewall 110 may have other suitable members for separating the receiving openings, e.g. a steel wall or parts thereof or any other suitable wall or parts thereof.

It can also be seen in FIG. 1 that the left receiving openings 111A-111C—in particularly the left receiving opening 111A and the right receiving opening 111C—are arranged substantially symmetrically on each side of the center of the body-in-white firewall 110. This is preferred since the truck cab 100 may have to be adapted to right-hand-traffic or left-hand-traffic. A symmetric position for the receiving openings 111A and 111C makes it possible to have the steering wheel adjustment on either the right side or the left side of the cab 100 without making any changes in the body-in-white firewall 110.

In addition, the body-in-white firewall 110 in FIG. 1 comprises an exemplifying windscreen member 112. The windscreen member 112 is preferably an elongated beam provided with a C-shaped recess, which beam forms a part of the upper long side of the fixedly attached body-in-white firewall 110. The windscreen member 112 extend in a substantially horizontal direction substantially perpendicular to the intended traveling direction of the truck cab 100 so as to support the front windscreen (not shown in FIG. 1) of the truck cab 100 at the lower horizontal side of the windscreen. Two substantially vertical A-pillars 120 are arranged to support the windscreen at its vertical sides and the roof of the cab 100. The windscreen member 112, the A-pillars and the roof define a substantially rectangular windscreen opening 130, which extends in a substantially vertical direction above the body-in-white firewall 110.

The truck cab 100 in FIG. 1 is further comprising: a floor 140 arranged for La. supporting passenger seats (not shown); an engine tunnel 150 arranged to accommodate at least a part, of the truck engine (not shown); and an instep 160 arranged to facilitate the entry into the truck cab 100.

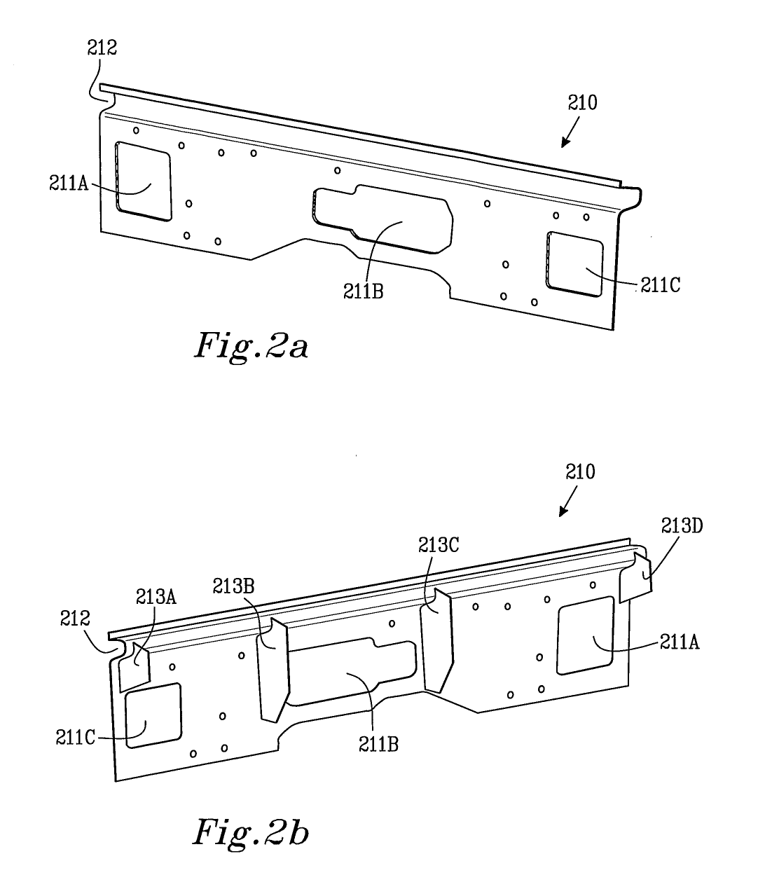

FIG. 2a shows a schematic view of an exemplifying inner firewall 210 according to an embodiment of the present invention. The exemplifying inner firewall 210 comprises three assembly openings 211A-211C adapted for a mounting of different cockpit units. It is preferred that the assembly openings 211A-211C in the inner firewall 210 are unique openings particularly adapted with small tolerances for a mounting of one or several specific cockpit units. Small tolerances imply that the assembly opening is slightly larger than the unit to be mounted into the opening, e.g. there may be only millimeters or fractions of millimeters between the unit and the edges of the assembly opening. This gives a more accurate unit, position and it improves the utilization of the material in the inner firewall 210. Naturally, the assembly openings can also be made smaller, which improves the stability of the inner wall 210.

The assembly openings 211A-211C in the inner firewall 210 correspond to the receiving openings 111A-111C in the body-in-white firewall 110, which receiving openings 111A-111C are arranged to receive one or several cockpit units mounted into the assembly openings 211A-211C in the inner firewall 210. For example, let us assume that the left receiving opening 111A of the body-in-white firewall 110 is arranged to receive pedal plate and steering wheel adjustment units, whereas the center receiving opening 111B is arranged to receive a HVAC unit and the right receiving opening 111C is arranged to receive an electrical central unit. Under this assumption the exemplifying inner firewall 210 will have its left assembly opening 211A adapted for an assembly of pedal plate and steering wheel adjustment units, whereas the center assembly opening 211B is adapted for an assembly of a HVAC unit and the right assembly opening 211C is adapted for an assembly of an electrical central unit.

The assembly openings 211A-211C in the inner firewall 210 are arranged so as to coincide with the receiving openings 111A-111C of the body-in-white firewall 110 upon an attachment of the outer side of the inner firewall 210 shown in FIG. 2a to the inner side of the body-in-white firewall 110 shown in FIG. 1. However, even if the openings 111A-111C and 211A-211C coincide there must not necessarily he a complete and identical match. On the contrary, the receiving openings 111A-111C can be larger than the assembly openings 211A-211C. The receiving openings 111A-111C and the assembly openings 211A-211C may also have different shapes, i.e. they must not necessarily have the same shape.

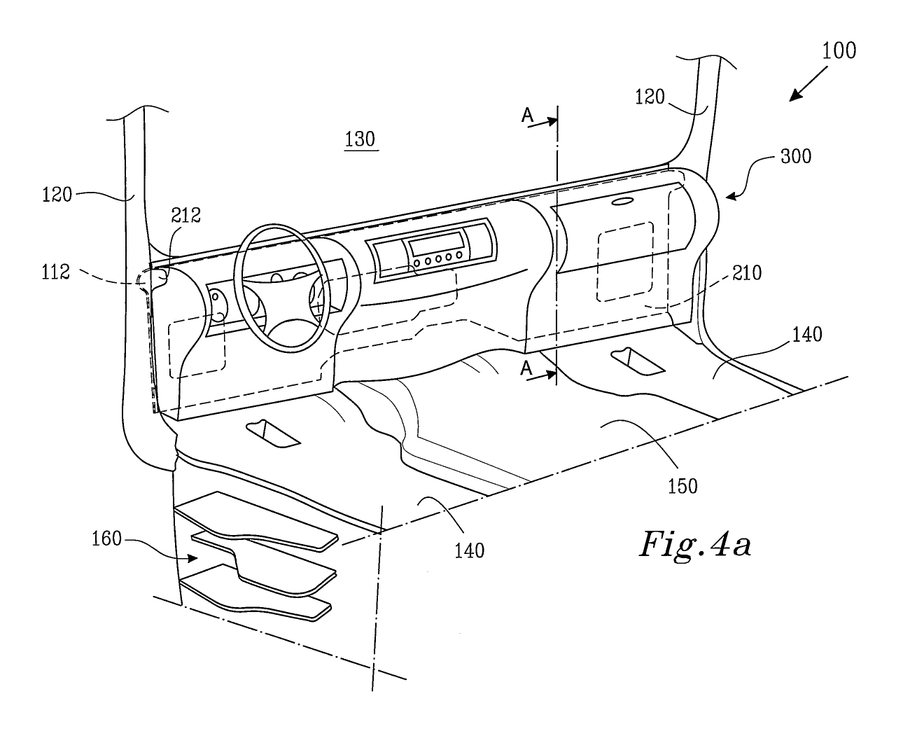

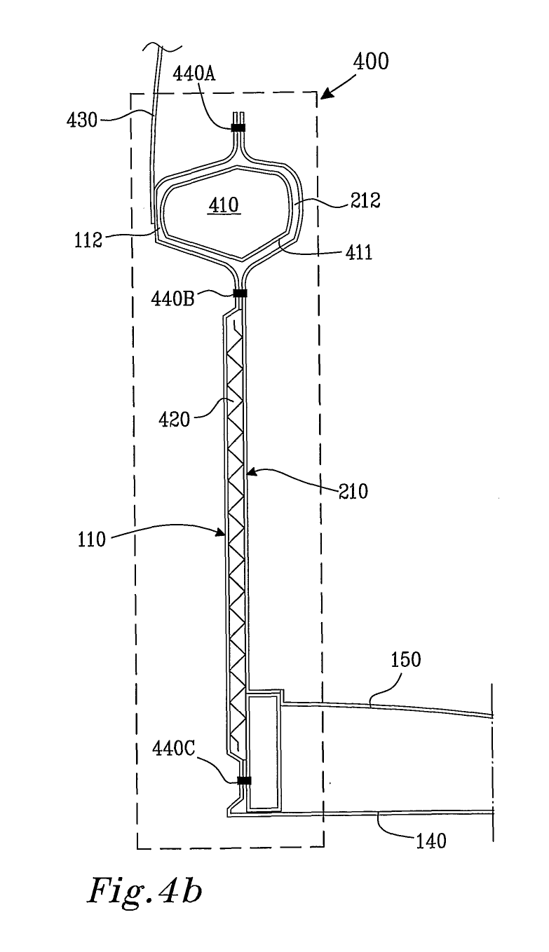

In addition, as can he seen in FIG. 2a the exemplifying inner firewall 210 comprises a recess in the form of a C-shaped elongated beam 212 at its upper long side. The C-shaped beam 212 is arranged so as to form a channel or duct when the outer side of the inner firewall 210 is attached onto the inner side of the body-in-white firewall 110. The duct and its advantages will be further described below with reference to FIG. 4b.

FIG. 2b shows the inner side of the inner firewall 210 in FIG 2a. The inner side of the inner firewall 210 is preferably provided with a plurality of assembly brackets 213A-213D. The particular inner firewall 210 in FIG. 2b is provided with four assembly brackets 213A-213D arranged in a vertical direction at the sides of the assembly openings 211A-211D to facilitate a mounting of cockpit sub-units into the assembly openings 211A-211C. Naturally there are other means, such as e.g. a framework arrangement, that can be used for facilitating a mounting of sub-units into the assembly openings 211A-211D.

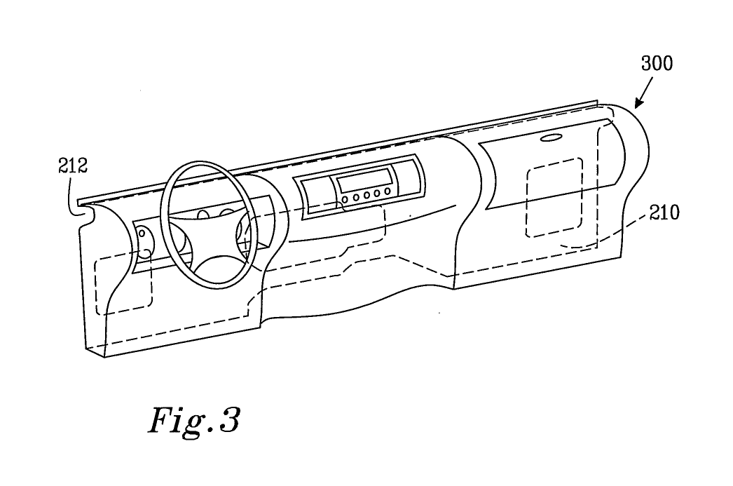

FIG. 3 shows the inner firewall 210 provided with cockpit sub-units mounted into the assembly openings 211A-211C thereof. The inner firewall 210 and the mounted cockpit sub-units form a sub-assembly in the form of a cockpit module 300. The cockpit module 300 is preferably completely assembled, i.e. substantially ail cockpit sub-units such as dashboard units and the above mentioned pedal plate unit, steering column adjustment unit, HVAC unit and electrical central unit etc. are mounted on the inner firewall 210. It is preferred that the substantially complete cockpit module 300 also comprises the typical outer shell 310 of a suitable plastic material which constitutes the interior panel surfaces seen by the driver and passengers in the cockpit.

From the above it should be clear that the sub-assembly in the form of an exemplifying cockpit module 300 is assembled without the use of any extra mounting jig or fixture or other support arrangement. Rather, the inner firewall 210 is used as a frame for assembling the cockpit module 300. This is a clear improvement compared to known assembling methods that use various mounting jigs or fixtures for the assembly of a cockpit module.

From the above it should also be clear that the body-in-white firewall 110 remains fixedly attached in the truck cab 100 while the inner firewall 210 is used as a frame for assembling the cockpit module 300. This is a clear advantage compared to solutions wherein the entire firewall is detached from the vehicle cab to be used as a frame for assembling a cockpit module. It is also a clear advantage in that an inner firewall 110 according to the present invention can be made much lighter than an entire firewall.

It is furthermore a clear advantage to have the body-in-white firewall 110 fixedly attached with respect to: the stability of the cab 100, an early mounting of parts that should be mounted on both the firewall 110 and the cab 100 and the fitting of a windscreen onto the firewall 110 and the rest of the cab 100.

In particularly with respect to the fitting of a windscreen it should be emphasized that a fixedly attached body-in-white firewall 110 according to the present invention provides a homogenous surface on winch the windscreen can be mounted. The homogenous surface has no assembly joints between the cab 100 and the firewall 110, which is the case if the entire firewall of a cab is used as a loose detached assembly frame. It follows that the present invention avoids the tolerance complications related to assembly joints between the cab and a detached loose firewall and the negative effects of such tolerance complications on the windscreen fitting. In addition, the homogenous surface produced by the body-in-white firewall 110 fixedly attached to the cab 100 according to the present invention does not require any joining or sealing between the cab 100 and the body-in-white firewall 110. Rather, the present invention has only one joint to be sealed, i.e. the joint between the windscreen and the cab 100, which homogenously includes the body-in-white firewall 110. In other words, there is no need for several different and possibly incompatible joining means and/or sealing means, which however is typically the case for the different joints in connection with a detached loose firewall (joints between; cab<->firewall; cab<->windscreen; firewall<->windscreen).

We will now proceed with a mounting into the cab 100 of the substantially complete cockpit module 300. We will also discuss the laminated firewall 400 accomplished by such a mounting.

FIG. 4a shows the cockpit module 300 mounted into the truck cab 100 shown in FIG. 1, which as previously described comprises the body-in-white firewall 110 with the C-shaped windscreen member 112, two A-pillars 120, a floor 140, an engine tunnel 150 and an instep 160.

The cockpit module 300 is preferably mounted by means of an assembly robot, though a manual mounting may be an alternative. The cockpit module 300 can e.g. be brought in to the cab 100 via a door opening or the windscreen opening 130. It is preferred that the cockpit module 300 is mounted towards the body-in-white firewall 110 by a final substantially horizontal movement in the Z-direction, i.e. in the same direction as the intended traveling direction of the cab 100. The cockpit module 300 is then preferably guided by guiding means, e.g. guiding pins (not shown), so as to assume the correct position towards the body-in-white firewall 110 before it is fixedly attached. The attachment of the exemplifying inner firewall 210 will be further discussed below.

FIG. 4b shows a cross-section of the mounted cockpit module 300 taken along the line A-A in FIG. 4a. Several parts of the cockpit module 300 have been omitted to produce a clearer view of the body-in-white firewall 110 and the inner firewall 210. FIG. 4b is also showing a side view of the engine tunnel 150 and the floor 140 previously mentioned with, reference to FIG. 1 and 4a. A. windscreen 430 mounted onto the body-in-white firewall 110 is also schematically illustrated in FIG. 4b.

As can be seen in FIG. 4b and partly in FIG. 4a the outer side of the inner firewall 210 is mounted towards the inner side of the body-in-white firewall 110, i.e. the cockpit module 300 is mounted towards the inner side of the body-in-white firewall 110 via the outer side of the inner firewall 210. The body-in-white firewall 110 and the inner firewall 210 are hereby creating a laminated firewall 400.

According to the embodiment of the invention shown in FIG. 4b a defroster duct 410 is formed by the C-shaped windscreen member 112 of the body-in-white firewall 110 and the C-shaped beam 212 of the inner firewall 210. As can be seen in FIG. 4b and partly in FIG. 4a the C-shaped windscreen member 112 and the C-shaped beam 212 are facing each other so as to form an oval-shaped defroster duct 410. However, even if the windscreen member 112 and the beam 212 are C-shaped in the present embodiment it should be emphasized that there are other shapes that can be used for the body-in-white firewall 110 and the inner firewall 210 which shapes would likewise create a defroster duct. Other shapes may e.g. be any suitable polygonal shape or any suitable curved or rounded shape or any suitable combination of polygonal and rounded shapes. It is preferred that the body-in-white firewall 110 comprises a first part of the shape and that the inner firewall 210 comprises a second part of the shape arranged so as to create a duct when the outer side of the inner firewall 210 is mounted towards the inner side of the body-in-white firewall 110.

In addition, it is preferred that the laminated firewall 400 is accomplished by arranging the body-in-white firewall 110 and the inner firewall 210 separated by a short distance, e.g. 10-50 millimeters. The distance between the two walls 110, 210 creates a compartment which is preferably filled with a suitable insulating material 420. If is preferred that the insulating material 420 is a sound insulating material, e.g. any well known and suitable sound insulating material commonly used in connection with sound insulation of passenger compartments in vehicles. It is also preferred that the insulating material 420 is a climate insulating material, e.g. any well known and suitable climate insulating material commonly used in connection with climate insulation of passenger compartments in vehicles. It is particularly preferred that the insulating material 420 is both sound insulating and climate insulating. This can be achieved by e.g. utilizing layers of different materials where a first material is sound insulating and a second material is climate insulating. This can also be achieved by e.g. utilizing the sound insulating properties of a climate insulating material or by utilizing the climate insulating properties of a sound insulating material, or by simply utilizing a material having satisfactory sound insulating properties and satisfactory climate insulating properties. The expression “climate insulating” should be understood as insulating from at least one of heat or cold and preferably from both heat and cold.

It is furthermore preferred that the cockpit module 300 is fixedly attached to the body-in-white firewall 110 by means of assembly points 440A-440C provided on the outside of the cab 100. This makes it easy for an assembly robot to access the assembly points 440a-440C for attaching the inner firewall 210 to the body-in-white firewall 110. The attachment can e.g. be accomplished by means of screwing, riveting, welding, soldering or even gluing, or a combination of two or several of these methods or by any other method suitable for joining such bodies as the inner firewall 210 and the body-in-white firewall 110.

The invention has now been described by means of embodiments, which should not be interpreted so as to limit the scope of the invention in any way. On the contrary, other modifications and variations can be made without departing from the invention defined by the appended claims.

### REFERENCE NUMBERS

100 Truck Cab
110 Body-in-White Firewall
111A Receiving Opening
111B Receiving Opening
111C Receiving Opening
112 Windscreen Member (C-shaped)
120 A-Pillar
130 Windscreen Opening
140 Floor
150 Engine Tunnel
160 Instep
210 Inner Firewall
211A Assembly Opening
211B Assembly Opening
211C Assembly Opening
211D Assembly Opening
212 Upper beam (C-shaped)
300 Cockpit Module
310 Outer Shell
400 Laminated Firewall
410 Defroster Duct
411 Defroster Duct Lining
420 Firewall Insulation (sound and/or climate)
430 Windscreen
440A Assembly point
440B Assembly point
440C Assembly point

1. A first wall adapted to form a part of a laminated wall in a vehicle body, which laminated wall comprises the first wall and a second wall that is fixedly attached to the vehicle body and provided with a plurality of receiving openings,
wherein
the first wall has a plurality of assembly openings each adapted to be provided with at least one sub-unit so as to form a substantially complete sub-assembly of the vehicle body; and
each assembly opening is arranged so as to substantially coincide with a corresponding receiving opening to form said the laminated wall when the outer side of the first wall is attached to the inner side of the second wall.

2. A first wall according to claim 1, wherein the first wall is provided with at least one assembly opening being unique with respect to at least one of shape and size so as to be particularly adapted for mounting of one or several specific sub-units.

3. A first wall according to claim 1, wherein the inner side is provided with at least one assembly means to facilitate a mounting of sub-units into the assembly openings.

4. A first wall according to claim 1, wherein the inner side is provided with sub-units mounted in the assembly openings so as to form a substantially complete sub-assembly to be mounted in the vehicle body.

5. A first wall according to claim 1, wherein the first wall is the an inner wall in a laminated wall constituting a partition wall arranged in front of the seat positions in a vehicle body.

6. A vehicle body with a laminated wall comprising a first wall and a second wall that is fixedly attached to the vehicle body and provided with a plurality of receiving openings, wherein
the first wall has a plurality of assembly openings each provided with at least one sub-unit so as to form a substantially complete sub-assembly of the vehicle body, and each being arranged so as to substantially coincide with a corresponding receiving opening when an outer side of the first wall is attached to an inner side of the second wall; and
the outer side of the first wall is attached to the inner side of the second wall so that each assembly opening substantially coincides with at least one receiving opening to form said the laminated wall.

7. A vehicle body according to claim 6, wherein the first wall is provided with at least one assembly opening being unique with respect to at least one of shape and size so as to be particularly adapted for mounting of one or several specific sub-units.

8. A vehicle body according to claim 6, wherein the inner side of the first wall is provided with sub-units mounted in the assembly openings so as to form a substantially complete sub-assembly.

9. A vehicle body according to claim 6, wherein the inner side of the first wall is provided with at least one assembly means for facilitating the mounting of sub-units into the assembly openings.

10. A vehicle body according to claim 6, wherein the second wall is provided with at least two receiving openings that are substantially symmetrically arranged on each side of the center of the second wall.

11. A vehicle body according to claim 6, wherein the outer side of the first wall has an elongated upper recess and the inner side of the second wall has a corresponding elongated upper recess, the elongated upper recess of the outer side of the first wall and the elongated upper recess of the inner side of the second wall together forming a duct.

12. A vehicle body according to claim 6, wherein the first wall is arranged a distance from the second wall so as to create a compartment between the walls that is filled with an insulating material being at least one of sound insulating and climate insulating.

13. A vehicle body according to claim 6, wherein the first wall is fixedly attached to the second wall by assembly points arranged on an outside of the vehicle body.

14. A vehicle body according to claim 6, wherein the vehicle body is a cab for a cargo carrying truck and the laminated wall is a partition wall arranged in front of the seat positions in the cab.

15. A method for forming a substantially complete sub-assembly of a vehicle body by using a first wall adapted to form a part of a laminated wall in the vehicle body, which laminated wall comprises the first wall and a second wall being fixedly attached to the vehicle body and provided with a plurality of receiving openings, comprising:
providing a first wall having a plurality of assembly openings each being arranged so as to substantially coincide with a corresponding receiving opening to form the laminated wall when the outer side of the first wall is attached to the inner side of the second wall; and
providing each assembly opening with at least one sub-unit so as to form a substantially complete sub-assembly of the vehicle body.

16. A method for mounting a substantially complete sub-assembly into a vehicle body having a laminated wall comprising a first wall and a second wall that is fixedly attached to the vehicle body and provided with a plurality of receiving openings, comprising:
providing a substantially complete sub-assembly comprising a first wall having a plurality of assembly openings each being provided with at least one sub-unit and each being arranged so as to substantially coincide with a corresponding receiving opening when an outer side of the first wall is attached to an inner side of the second wall; and
attaching the outer side of the first wall to the inner side of the second wall so that each assembly opening substantially coincides with at least one receiving opening to form the laminated wall.

17. A method according to claim 15, wherein the vehicle body is a cab for a cargo carrying truck and the laminated wall is a partition wall arranged in front of the seat positions in the cab.
